(19) United States
(12) Patent Application Publication
(10) Pub. No.: US 2023/0330799 A1
(43) Pub. Date: Oct. 19, 2023

(54) MACHINE TOOL

(71) Applicant: Siemens Aktiengesellschaft, 80333 München (DE)

(72) Inventors: JOCHEN BRETSCHNEIDER, Owingen (DE); TORSTEN SCHÜR, Erlangen (DE); ELMAR SCHÄFERS, Fürth (DE)

(73) Assignee: Siemens Aktiengesellschaft, 80333 München (DE)

(21) Appl. No.: 18/012,836

(22) PCT Filed: Jun. 14, 2021
(86) PCT No.: PCT/EP2021/065891

§ 371 Date: Dec. 23, 2022

(30) Foreign Application Priority Data
Jun. 24, 2020 (EP) 20182020.6

(51) Int. Cl. B23Q 11/00

(52) U.S. Cl. CPC B23Q 11/0032

(57) ABSTRACT

A machine tool includes a machine element and a vibration damper arranged on the machine element to damp a vibration mode that occurs during operation of the machine tool and is manifested at a tool center point of the machine tool and at a point of the machine element. The vibration damper is arranged on the point of the machine element, with the vibration mode having a vibration antinode at the point.

The invention relates to a machine tool comprising at least one machine element, wherein at least one vibration damper is arranged on the machine element to damp a vibration mode that occurs during operation of the machine tool and is manifested at a tool center point of the machine tool.

Machine tools of the aforementioned type are sufficiently well known from the prior art. EP 3 017 911 A1, EP 3 241 647 A1, EP 3 511 112 A1 and U.S. Pat. No. 6,296,093 B1 show possible arrangements of the vibration dampers. Herein, the vibration dampers are mounted on a ram of the machine tool as closely as possible to a tool center point (TCP) or integrated in the ram in order to avoid collisions during machining.

However, attaching vibration dampers as closely as possible to the TCP often leads to problems. If the vibration damper is not integrated in the ram (U.S. Pat. No. 6,296,093 B1), this can result in undesirable collisions in the working area. The integration of vibration dampers into the ram (EP 3 017 911 A1, EP 3 241 647 A1) is complicated and not always possible due to limited space inside the ram. Integration also requires vibration dampers of a certain relatively small size and this results in reduced performance and therefore in less effective damping.

The object of the present invention can be considered to be the provision of a machine tool with vibration dampers in which the vibration dampers can be attached in a simple manner and at low cost and, at the same time, the quality of the damping can be improved.

According to the invention, the aforementioned object is achieved with a machine tool of the aforementioned type in that the vibration mode is manifested at at least one point of the at least one machine element, wherein the at least one vibration damper is arranged on the at least one point.

The vibrations that occur during operation of a machine tool can originate in different ways. Possible sources of the excitation of vibrations are the drive systems of the machine, the machining process or the machining, etc.

Undesirable, for example transverse, vibration modes of these vibrations are to be damped. An undesirable mode generally has a negative impact on (in the context of the machine tool) productivity, for example because it leads to increased tool wear, and/or to quality losses and/or the development of noise and/or productivity-limiting chatter (oscillation that has to be prevented by reducing the infeed of the tool into the workpiece). The modes to be damped can usually be seen at the tool center point.

The statement that a vibration mode is manifested at a point means that the vibration mode can be detected at this point and preferably has an amplitude that is approximately the same as the maximum amplitude of this vibration mode.

In other words, in the context of the invention, a mode that is disruptive at one tool center point is damped at another point which is arranged on or in a machine element.

The term “tool center point” should be understood to mean a tool reference point (tool center point) relative to the workpiece.

The points at which the vibration mode is manifested, for example has a vibration antinode, can, for example, be determined before the attachment of the vibration damper by exciting a vibration of a certain frequency, for example a low frequency (for example less than 100 Hz), and measuring the machine elements, for example by means of vibration sensors.

Passive vibration dampers and active vibration dampers are known for suppressing or damping such vibration modes. However, neither passive nor active vibration dampers serve the actual operation of the machine tool. Rather, they serve to reduce and, if possible, even eliminate, an undesirable side effect that occurs during operation of the machine tool—namely oscillations and vibrations.

Passive vibration dampers contain moving masses that can act on the machine element of which the vibration is to be damped. However, active vibration dampers contain actively actuated elements via which a force can be directly exerted on the corresponding machine element. During operation of the machine tool, the corresponding active vibration damper is also actively actuated.

In one embodiment, it can advantageously be provided that the vibration mode is manifested at at least two points of the at least one machine element and the machine tool has at least two vibration dampers, wherein different vibration dampers are arranged at different points. These different points can (but do not have to) be located at different vibration antinodes.

Moreover, it can be expedient for the at least one vibration damper to be arranged on an outer surface of the at least one machine element or partially protrude into the at least one machine element or be integrated in the at least one machine element in such a way that it does not protrude beyond an outer surface of the at least one machine element.

It can advantageously be provided that the at least one point or each point is located at a vibration antinode of the vibration mode.

In one embodiment, it can be provided that the at least one vibration damper is embodied to damp at least one spatial component of the vibration mode.

It can be appropriate for the at least one vibration damper to be embodied as an active vibration damper or as an inertial damper (inertial actuator).

In one embodiment, the machine tool can comprise a further machine element, wherein the at least one machine element supports the further machine element, wherein the further machine element is movable with respect to the at least one machine element. The machine elements can be moved by means of the drives of the machine tool, wherein the movable element can be movable in a position-controlled manner in a direction of movement.

In one embodiment, it can be provided that the at least one machine element is embodied as a machine-tool-side machine element.

Moreover, it can be appropriate for the machine-tool-side machine element to have a first end and a second end opposite the first end, wherein a receptacle is embodied at the first end and the at least one vibration damper is arranged at the second end. Herein, a machining head with a machining tool can be accommodated in the receptacle.

Moreover, it can be provided that the at least one machine element is embodied as a workpiece-side machine element.

In one embodiment, it can be provided that the at least one machine element is embodied as a fixed machine element.

The fixed machine element can, for example, be a machine element that supports one or more other machine elements and with respect to which this machine element or these machine elements is or are movable.

In one embodiment, it can be provided that two or more vibration modes occur during operation of the machine tool.

Herein, it can be expedient for two or more vibration dampers to be provided (for damping) for each vibration mode.

It can also be appropriate for the at least one vibration damper to be aligned in a main direction of manifestation of the vibration mode.

The following describes and explains the invention in more detail with reference to the exemplary embodiments depicted in the figures, in which:

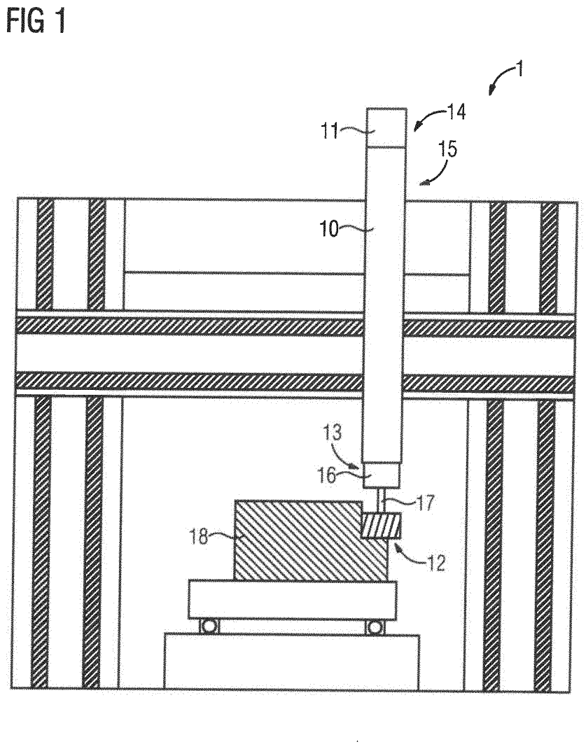

FIG. 1 shows a milling machine,

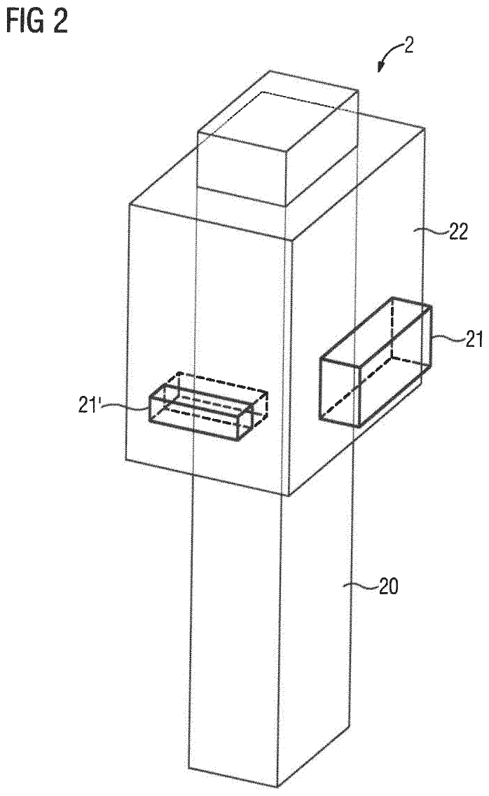

FIG. 2 shows a section of a machine tool,

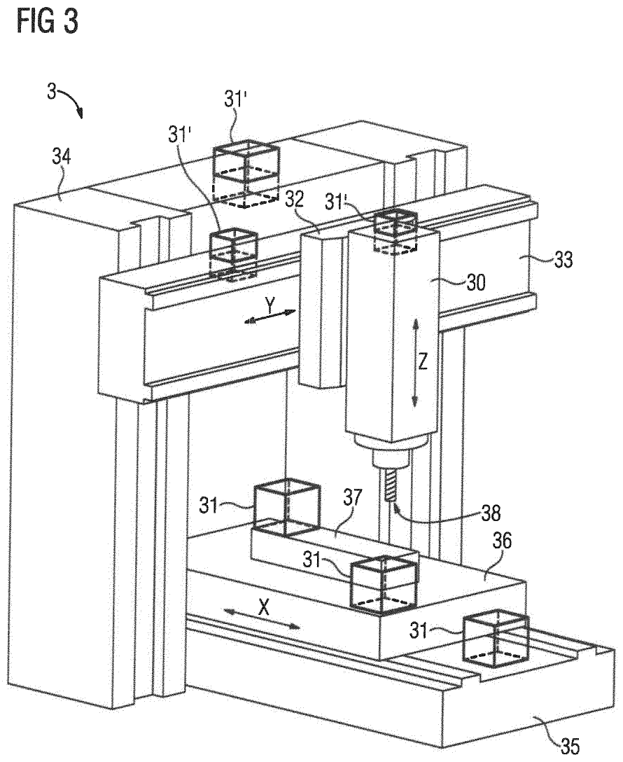

FIG. 3 shows a perspective view of a table-top machine tool,

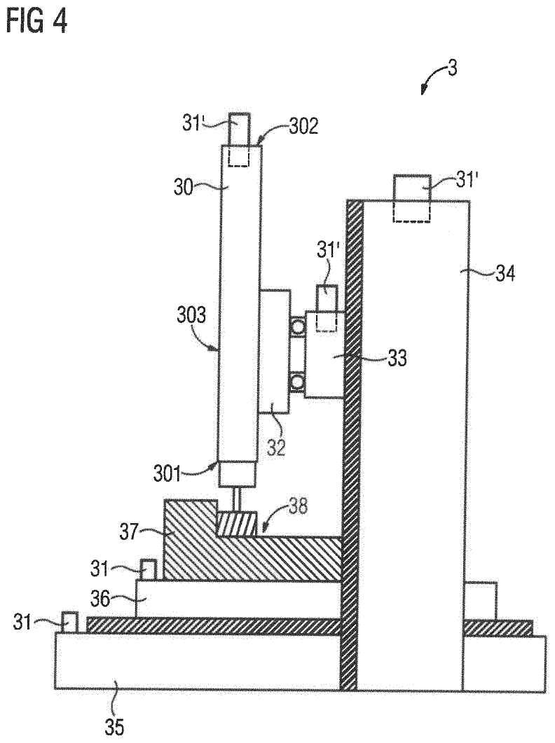

FIG. 4 shows a side view of the machine tool in FIG. 3, and

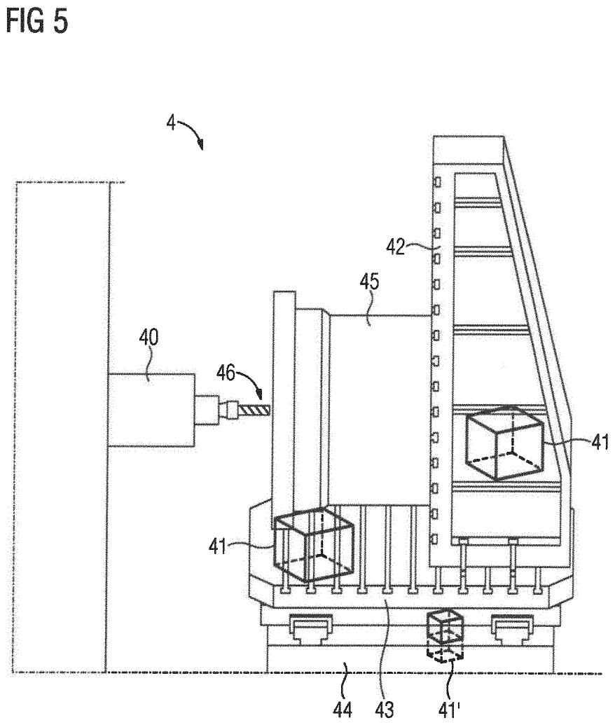

FIG. 5 shows a further machine tool.

In the exemplary embodiments and figures, elements that are the same or have the same effect can each be provided with the same reference symbols.

First, reference is made to FIG. 1. This is a schematic depiction of a possible embodiment of the machine tool according to the invention—a milling machine 1.

In addition to other machine elements shown, the milling machine 1 comprises a support arm 10 that can be moved in three mutually orthogonal directions by means of drives (not shown here). The support arm 10—also called a punch or ram—is a projecting machine-tool-side machine element. The support arm 10 has a square cross section, for example. Further, the support arm 10 can comprise a first end 13 and a second end 14, wherein the first end 13 is opposite the second end 14 and has a receptacle. The ram 10 supports a machining head 16, which is mounted in the receptacle and accommodates a machining tool 17. The two ends 13 and 14 of the ram 10 are connected via longitudinal sides 15 of the ram 10.

A vibration damper 11 is arranged at the second end 14. The vibration damper 11 is attached to an outer surface of the ram 10. In particular, the vibration damper 11 does not protrude into the interior of the ram 10. In this case, it is easy to connect the vibration damper 11 to further apparatuses, for example to a vibration damper regulator (not shown here). Alternatively, it is conceivable that the vibration damper is at least partially sunk into the interior of the ram so that it protrudes partially into the ram 10. It is also possible to fully integrate the vibration damper into the ram 10 so that it does not protrude beyond the outer surface of the ram 10.

During operation of the milling machine 1, for example when a workpiece 18 is machined with the tool 17 or the ram 10 is moved, vibrations are generated in the ram 10 and also in other machine-tool-side and/or workplece-side, movable and/or fixed machine elements. The vibrations can comprise a plurality of vibration modes. One or more of these vibration modes can be undesirable because, for example, they have a negative effect on productivity, for example due to increased tool wear and/or reduced machining quality, for example due to inaccurate machining of the workpiece and/or are responsible for an excessively high noise level. This can, for example, entail transverse vibration modes. The vibration mode is manifested, for example is visible, at a tool center point 12 of the milling machine 1.

In addition, the vibration mode is manifested, for example visible, at at least one point of the ram 10.

The vibration damper 11 is provided to damp a disruptive/undesirable vibration mode of this kind and is arranged on the at least one point. This point can, for example, be embodied as a vibration antinode. FIG. 1 shows that the at least one point can be located at the second end 14 of the ram 10.

Thus, a vibration mode that has a disruptive effect at the tool center point can be damped at another point. FIG. 2 shows a further example where this general inventive idea is valid. FIG. 2 is a schematic view of a section of a machine tool 2. The machine tool 2 can be embodied as a machine for milling, drilling, etc. FIG. 2 shows a slide 22 that supports a punch 20. The punch 20 is arranged in the slide 22 so as to be movable in its longitudinal direction. At its lower end in the image plane, the punch 20 can have a machining head (not shown here). During operation of the machine tool 2, the undesirable vibration modes mentioned with respect to FIG. 1 can, for example, occur when the slide 22 is moved in one of the two in relation to the longitudinal direction of the punch 20 or a workplece (not shown here) is machined.

The vibration mode can be two-dimensional or three-dimensional. FIG. 2 shows two vibration dampers 21, 21′, wherein each vibration damper 21, 21′ is aligned in a main direction of manifestation of a two-dimensional vibration mode. The vibration damper 21 is fixed on an outer surface of the slide 22 and configured to damp the vibration mode in the X direction. The vibration damper 21′ is integrated in the slide 22 and configured to damp the vibration mode in the Y direction.

At this point, it should be noted that a vibration mode can have two or more vibration anodes and can be manifested at two, three, four or more points.

FIG. 2 shows an arrangement in which the two vibration dampers 21 and 21′ are arranged at the points of manifestation of the vibration mode belonging to the same vibration antinode. An arrangement of vibration dampers at different vibration antinodes is also conceivable.

FIG. 3 shows a perspective view of a table-top machine tool 3. FIG. 4 is a side view of the machine tool in FIG. 3. The machine tool 3 comprises a ram 30 that is supported by a supporting element 32 (also called a guide carriage) and is movable along the W axis. Here, the W axis is, for example vertical, parallel to the Z direction. The supporting element 32 is supported by a guide element 33 and arranged on the guide element so as to be movable in the Y direction or longitudinal direction of the guide element 33. The guide element 33 is arranged on a fixed machine element 34—a gantry—so as to be movable in the Z direction. The ram 30, the supporting element 32 and the guide element 33 are movable machine-tool-side machine elements. The fixed machine element 34 is an immobile machine-tool-side machine element.

Moreover, the machine tool 3 has workpiece-side machine elements: a machine base 35 (a fixed machine element), a machine table 36 and a workpiece receptacle or adapter 37. Guides are embodied on the machine base 35 along which the machine table 36 is arranged so as to be movable in the X direction.

The X, Y and Z directions are orthogonal to one another. Drives of the machine tool arranged to move the movable elements in the X, Y, Z direction are not shown.

The ram 30 is embodied as a support arm with a square cross section and has a first and a second end 301 and 302 connected via side surfaces 303.

A machining head with a tool is mounted on a first end 301 of the ram 30.

Vibrations with (at least) one manifested and disruptive vibration mode at the tool center point 38 also occur during operation of this machine tool 3. As already mentioned, the vibration mode can be manifested at a plurality of points of the machine tool 3. FIG. 3 shows that a vibration damper 31, 31′ can be placed on each point at which the vibration mode can be manifested. A joint examination of FIG. 3 and FIG. 4 reveals that a vibration damper 31, 31′ can in each case be mounted at each of the aforementioned machine elements 30, 32, 33, 34, 35, 36, 37 of the machine tool 3. For example, a vibration damper 31′ can be partially integrated into a second end 302 of the ram 30 opposite the first end 301 of the ram 30. The vibration dampers 31 are mounted on the respective outer surfaces, wherein the vibration dampers 31′ partially protrude into the respective machine elements 30, 33, 34. It is quite conceivable that a vibration damper is also attached to the supporting element 32 at the top—in the image plane in FIG. 4 —, for example partially or completely integrated in the supporting element 32.

FIG. 5 shows a machine tool 4 comprising a (cylindrical) punch 40 or ram and—on the workplece side—a workpiece receptacle 42, a machine table 43 and a machine base 44. The machine tool 4 also comprises further elements that can be seen in FIG. 4, but which will not be further discussed here. FIG. 4 also shows a workpiece 45 clamped in the adapter 42. The tool center point 46 is located at the end of a tool accommodated in the punch 40.

The above-described vibrations also occur with this machine tool 4 during operation of the machine tool 4. Here, a total of three vibration dampers 41, 41′ are provided to damp disruptive vibrations—on the workpiece receptacle 42, on the machine table 43 and on the machine base 44 respectively. One vibration damper can be arranged on the ram 40 (not shown).

The above-described machine tools are generally configured for milling, drilling, finishing, roughing, chamfering, etc.

The vibration dampers used are preferably active. However, it is also possible to use passive or inertial dampers.

The vibration modes in question to be damped in connection with the present invention preferably have a low frequency, for example less than approximately 100 Hz, in particular between approximately 50 Hz and approximately 70 Hz.

Although the invention has been illustrated and described in greater detail by exemplary embodiments, the invention is not restricted by the disclosed examples. Variations thereof can be derived by the person skilled in the art without departing from the scope of protection of the invention as defined by the following claims.

1.-14. (canceled)

15. A machine tool, comprising:
a machine element; and
a vibration damper arranged on the machine element to damp a vibration mode that occurs during operation of the machine tool and is manifested at a tool center point of the machine tool and at a point of the machine element, said vibration damper arranged on the point of the machine element, with the vibration mode having a vibration antinode at the point.

16. The machine tool of claim 15, wherein the vibration mode is manifested at at least two different points of the machine element, and further comprising a further vibration damper, with the vibration damper and the further vibration damper arranged at the different points.

17. The machine tool of claim 15, wherein the vibration damper is arranged in one of three ways, a first way in which the vibration damper is arranged on an outer surface of the machine element, a second way in which the vibration damper partially protrudes into the machine element, a third way in which the vibration damper is integrated in the machine element in such a way that the vibration damper does not protrude beyond an outer surface of the machine element.

18. The machine tool of claim 15, wherein the vibration damper is embodied to damp a spatial component of the vibration mode.

19. The machine tool of claim 15, wherein the vibration damper is embodied as an active vibration damper.

20. The machine tool of claim 15, further comprising a further machine element supported by the machine element and movable with respect to the machine element.

21. The machine tool of claim 15, wherein the machine element is embodied as a machine-tool-side machine element.

22. The machine tool of claim 21, wherein the machine-tool-side machine element includes a first end and a second end opposite the first end, said vibration damper being arranged at the second end.

23. The machine tool of claim 22, wherein the first end of the machine-tool-side machine element is formed with a receptacle for receiving a machining head.

24. The machine tool of claim 15, wherein the machine element is embodied as a workpiece-side machine element.

25. The machine tool of claim 15, wherein the machine element is embodied as a fixed machine element.

26. The machine tool of claim 15, wherein, during operation of the machine tool, two or more vibration modes are manifested at the machine tool.

27. The machine tool of claim 26, further comprising two or more vibration dampers for each of the two or more vibration modes.

28. The machine tool of claim 15, wherein the vibration damper is aligned in a main direction of manifestation of the vibration mode.
